(19) United States
(12) Patent Application Publication
(10) Pub. No.: US 2018/0349061 A1
(43) Pub. Date: Dec. 6, 2018

(54) OPERATION PROCESSING APPARATUS, INFORMATION PROCESSING APPARATUS, AND METHOD OF CONTROLLING OPERATION PROCESSING APPARATUS

(71) Applicant: FUJITSU LIMITED, Kawasaki-shi (JP)

(72) Inventors: Tomohiro Nagano, Yokohama (JP); Masaki Ukai, Kawasaki (JP); Masanori Higeta, Setagaya (JP)

(73) Assignee: FUJITSU LIMITED, Kawasaki-shi (JP)

(21) Appl. No.: 15/990,854

(22) Filed: May 29, 2018

(30) Foreign Application Priority Data
Jun. 6, 2017 (JP) 2017-111695

(51) Int. Cl. G06F 3/06; G06F 17/16

(52) U.S. Cl. CPC G06F 3/0659; G06F 17/16; G06F 3/0683; G06F 3/0604

(57) ABSTRACT

An operation processing apparatus includes: a plurality of operation elements; a plurality of first data storages disposed so as to correspond to the respective operation elements and each configured to store first data; and a shared data storage shared by the plurality of operation elements and configured to store second data, each of the plurality of operation elements are configured to perform an operation using the first data and the second data.

### CROSS-REFERENCE TO RELATED APPLICATION

This application is based upon and claims the benefit of priority of the prior Japanese Patent Application No. 2017-111695, filed on Jun. 6, 2017, the entire contents of which are incorporated herein by reference.

### FIELD

The embodiments discussed herein are related to an operation processing apparatus, an information processing apparatus, and a method of controlling an operation processing apparatus.

### BACKGROUND

In a multiprocessor system, a plurality of processors are used.

Related technique are disclosed in Japanese Laid-open Patent Publication No. 64-57366, or Japanese Laid-open Patent Publication No. 60-37064.

### SUMMARY

According to an aspect of the embodiments, an operation processing apparatus includes: a plurality of operation elements; a plurality of first data storages disposed so as to correspond to the respective operation elements and each configured to store first data; and a shared data storage shared by the plurality of operation elements and configured to store second data, each of the plurality of operation elements are configured to perform an operation using the first data and the second data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an information processing apparatus;

FIG. 2 illustrates an example of an execution unit;

FIG. 3 illustrates an example of an execution unit;

FIG. 4 illustrates an example of an execution unit;

FIG. 5 illustrates an example of a set of eight FMA operation units in an operation execution unit;

FIG. 6 illustrates an example of an execution unit;

FIG. 7 illustrates an example of an execution unit;

FIG. 8 illustrates an example of an execution unit;

FIG. 9 illustrates an example of an execution unit;

FIG. 10 illustrates an example of an address map of a shared vector register and a local vector register;

FIG. 11 illustrates an example of a method of controlling an operation processing apparatus;

FIG. 12 illustrates an example of an execution unit;

FIG. 13 illustrates an example of an execution unit;

FIG. 14 illustrates an example of a method of controlling an operation processing apparatus;

FIG. 15 illustrates an example of an execution unit; and

FIG. 16 illustrates an example of a method of controlling an operation processing apparatus.

### DESCRIPTION OF EMBODIMENTS

In a multiprocessor system, for example, a set of vector registers is shared by at least two or more processors such that the processors are capable of accessing these vector registers. Each vector register has a capability of identifying processors that are allowed to access the vector register and a capability of storing a vector register value including a plurality of pieces of vector element data. Each vector register also has a capability of displaying a status of each vector element data and controlling a condition of referring to the vector element data.

The multiprocessor system includes, for example, a central storage apparatus having a plurality of access paths, a plurality of processing apparatuses, and a connection unit. Each of the plurality of processing apparatuses has an internal information path and is connected to the access path to the central storage apparatus via a plurality of ports. Each port is configured to receive a reference request from a processing apparatus via the internal information path and generate and control a memory reference to the central storage apparatus via the access path. The connection unit connects one or more shared registers to information paths of the respective processing apparatuses such that the one or more shared registers are allowed to be accessed at a rate corresponding to an internal operation speed of the processors.

In the multiprocessor system, use of a plurality of processors makes it possible to increase the operation speed. For example, in a case where a large amount of data is transferred in an operation performed by the processors, it takes a long time to transfer the data, and thus a reduction in operation efficiency occurs even if the number of processors provided in the multiprocessor system is increased. For example, in a case where the vector register has a large capacity, this may result in an increase in area size of the and an increase in cost.

For example, an operation processing apparatus may be provided that is configured to reduce the amount of data transferred in an operation performed by an operation unit and/or to reduce the capacity of a data storage unit.

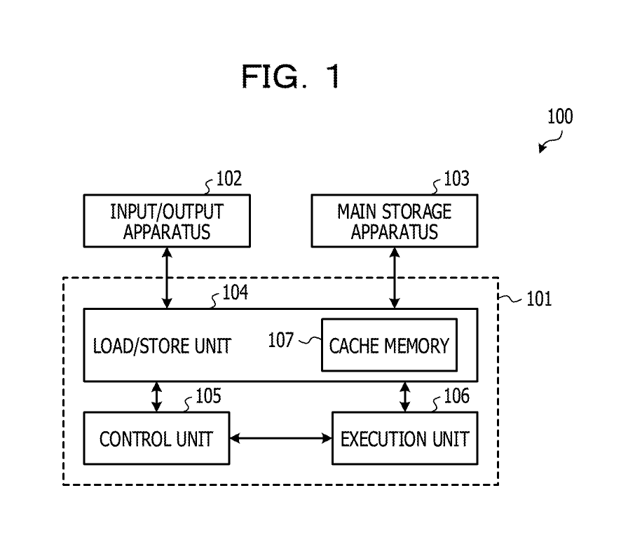

FIG. 1 illustrates an example of an information processing apparatus. The information processing apparatus 100 is, for example, a computer such as a server, a supercomputer, or the like, and includes an operation processing apparatus 101, an input/output apparatus 102, and a main storage apparatus 103. The input/output apparatus 102 includes a keyboard, a display apparatus, and a hard disk drive apparatus, and the like. The main storage apparatus 103 is a main memory and is configured to store data. The operation processing apparatus 101 is connected to the input/output apparatus 102 and the main storage apparatus 103.

The operation processing apparatus 101 is, for example, a processor and includes a load/store unit 104, a control unit 105, and an execution unit 106. The control unit 105 controls the load/store unit 104 and the execution unit 106. The load/store unit 104 includes a cache memory 107 and is configured to input/output data from/to the input/output apparatus 102, the main storage apparatus 103, and the execution unit 106. The cache memory 107 stores one or more instructions and data which are included in those stored in the main storage apparatus 103 and which are used frequently. The execution unit 106 performs an operation using data stored in the cache memory 107.

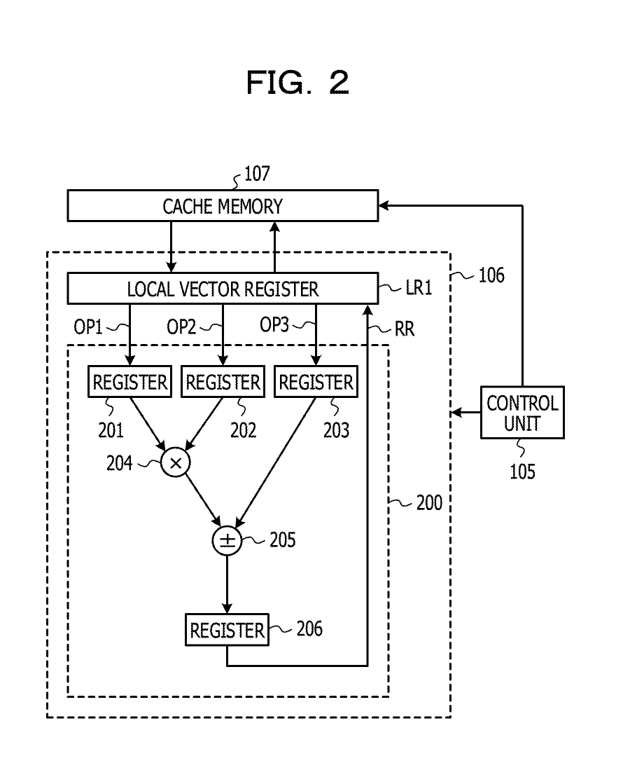

FIG. 2 illustrates an example of an execution unit. The execution unit 106 includes a local vector register LR1 serving as a data storage unit and an FMA (fused multiply-add) operation unit 200. The FMA operation unit 200 is a multiply-add processing unit that performs a multiply-add operation and includes registers 201 to 203, a multiplier 204, an adder/subtractor 205, and a register 206.

The control unit 105 performs transferring of data between the cache memory 107 and the local vector register LR1. The local vector register LR1 stores data OP1, data OP2, and data OP3. The register 201 stores the data OP1 output from the local vector register LR1. The register 202 stores the data OP2 output from the local vector register LR1. The register 203 stores the data OP3 output from the local vector register LR1.

The multiplier 204 multiplies the data OP1 stored in the register 201 by the data OP2 stored in the register 202 and outputs a result of the multiplication. The adder/subtractor 205 performs an addition or subtraction between the data output from the multiplier 204 and the data OP3 stored in the register 203 and output a result of the operation. The register 206 stores the data output from the adder/subtractor 205 and outputs the stored data RR to the local vector register LR1.

The execution unit 106 calculates a product of matrix data A and matrix data B as described in equation (1) and outputs matrix data C. The matrix data A is data having m rows and n columns. The matrix data B is data having n rows and p columns. The matrix data C is data having m rows and p columns.

$$A = ( \begin{matrix}{a}_{11} & ⋯ & {a}_{1 n} \\ ⋮ & ⋱ & ⋮ \\ {a}_{m 1} & ⋯ & {a}_{mn}\end{matrix} ) , B = ( \begin{matrix}{b}_{11} & ⋯ & {b}_{1 p} \\ ⋮ & ⋱ & ⋮ \\ {b}_{n 1} & ⋯ & {b}_{np}\end{matrix} ) , C = ( \begin{matrix}{c}_{11} & ⋯ & {c}_{1 p} \\ ⋮ & ⋱ & ⋮ \\ {c}_{m 1} & ⋯ & {c}_{mp}\end{matrix} ) \qquad ( 1 )$$

Element data cᵢⱼ of the matrix data C is expressed by equation (2). Element data aᵢₖ is element data of the matrix data A. Element data bₖⱼ is element data of the matrix data B.

cᵢⱼ=Σₖ₌₁ⁿaᵢₖbₖⱼ (2)

For example, element data c₁₁ is described by equation (3). The execution unit 106 determines the element data c₁₁ by calculating a sum of products between first row data a₁₁, a₁₁, a₁₂, a₁₃, a₁₄, . . . , a₁ₙ of the matrix data A and first column data b₁₁, b₂₁, b₃₁, b₄₁, . . . , bₙ₁ of the matrix data B.

c₁₁=a₁₁b₁₁+a₁₂b₂₁+a₁₃b₃₁+a₁₄b₄₁+ . . . +a₁ₙbₙ₁ (3)

The control unit 105 transfers the matrix data A and the matrix data B stored in the cache memory 107 to the local vector register LR1 serving as the data storage unit. In a first cycle, the local vector register LR1 outputs element data a₁₁ as the data OP1, element data b₁₁ as the data OP2, and 0 as the data OP3. The FMA operation unit 200 calculates OP1×OP2+OP3 thereby obtaining a₁₁b₁₁ as a result, and outputs the result as the data RR. The local vector register LR1 stores a₁₁b₁₁, as the data RR.

In a second cycle, the local vector register LR1 outputs element data a₁₂ as the data OP1, element data b₂₁ as the data OP2, and, as the data OP3, the data RR (=a₁₁b₁₁) obtained in the previous cycle. The FMA operation unit 200 calculates OP1×OP2+OP3 thereby obtaining a₁₁b₁₁+a₁₂b₂₁ as a result, and outputs the result as the data RR. The local vector register LR1 stores a₁₁b₁₁+a₁₂b₂₁ as the data RR.

In a third cycle, the local vector register LR1 outputs element data a₁₃ as the data OP1, element data b₃₁ as the data OP2, and, as the data OP3, the data RR (=a₁₁b₁₁+a₁₂b₂₁) obtained in the previous cycle. The FMA operation unit 200 calculates OP1×OP2+OP3 thereby obtaining a₁₁b₁₁+a₁₂b₂₁+a₁₃b₃₁ as a result, and outputs the result as the data RR. The local vector register LR1 stores a₁₁b₁₁+a₁₂b₂₁+a₁₃b₃₁ as the data RR. Thereafter, the execution unit 106 performs a similar process repeatedly to obtain element data c₁₁ according to equation (3).

The control unit 105 may store data in the local vector register LR1 such that only the data RR obtained as element data c₁₁ in a final cycle is stored, but data RR obtained in middle cycles is not stored in the local vector register LR1.

Element data c₁₂ is described by equation (4). The execution unit 106 determines the element data c₁₂ by calculating a sum of products between first row data a₁₁, a₁₂, a₁₃, a₁₄, . . . , a₁ₙ of the matrix data A and second column data b₁₂, b₂₂, b₃₂, b₄₂, . . . , bₙ₂ of the matrix data B.

c₁₂=a₁₁b₁₂+a₁₂b₂₂+a₁₃b₃₂+a₁₄b₄₂+ . . . +a₁ₙbₙ₂ (4)

Element data c₁ₚ is described by equation (5). The execution unit 106 determines the element data c₁ₚ by calculating a sum of products between first row data a₁₁, a₁₂, a₁₃, a₁₄, . . . , a₁ₙ of the matrix data A and pth column data b₁ₚ, b₂ₚ, b₃ₚ, b₄ₚ, . . . , bₙₚ of the matrix data B.

c₁ₚ=a₁₁b₁ₚ+a₁₂b₂ₚ+a₁₃b₃ₚ+a₁₄b₄ₚ+ . . . +a₁ₙbₙₚ (5)

Element data cₘ₁ is described by equation (6). The execution unit 106 determines the element data cₘ₁ by calculating a sum of products between mth row data aₘ₁, aₘ₂, aₘ₃, aₘ₄, . . . , aₘₙ of the matrix data A and first column data b₁₁, b₂₁, b₃₁, b₄₁, . . . , bₙ₁ of the matrix data B.

cₘ₁=aₘ₁b₁₁+aₘ₂b₂₁+aₘ₃b₃₁+aₘ₄b₄₁+ . . . +aₘₙbₙ₁ (6)

Element data cₘ₂ is described by equation (7). The execution unit 106 determines the element data cₘ₂ by calculating a sum of products between mth row data aₘ₁, aₘ₂, aₘ₃, aₘ₄, . . . , aₘₙ of the matrix data A and second column data b₁₂, b₂₂, b₃₂, b₄₂, . . . , bₙ₂ of the matrix data B.

cₘ₂=aₘ₁b₁₂+aₘ₂b₂₂+aₘ₃b₃₂+aₘ₄b₄₂+ . . . +aₘₙbₙ₂ (7)

Element data cₘₚ is described by equation (8). The execution unit 106 determines the element data cₘₚ by calculating a sum of products between mth row data aₘ₁, aₘ₂, aₘ₃, aₘ₄, . . . , aₘₙ of the matrix data A and pth column data b₁ₚ, b₂ₚ, b₃ₚ, b₄ₚ, . . . , bₙₚ of the matrix data B.

cₘₚ=aₘ₁b₁ₚ+aₘ₂b₂ₚ+aₘ₃b₃ₚ+aₘ₄b₄ₚ+ . . . +aₘₙbₙₚ (8)

As described above, the data OP1 is the matrix data A, the data OP2 is the matrix data B, and the data RR is the matrix data C. In the local vector register LR1, the matrix data C is written. The control unit 105 transfers the matrix data C stored in the local vector register LR1 to the cache memory 107.

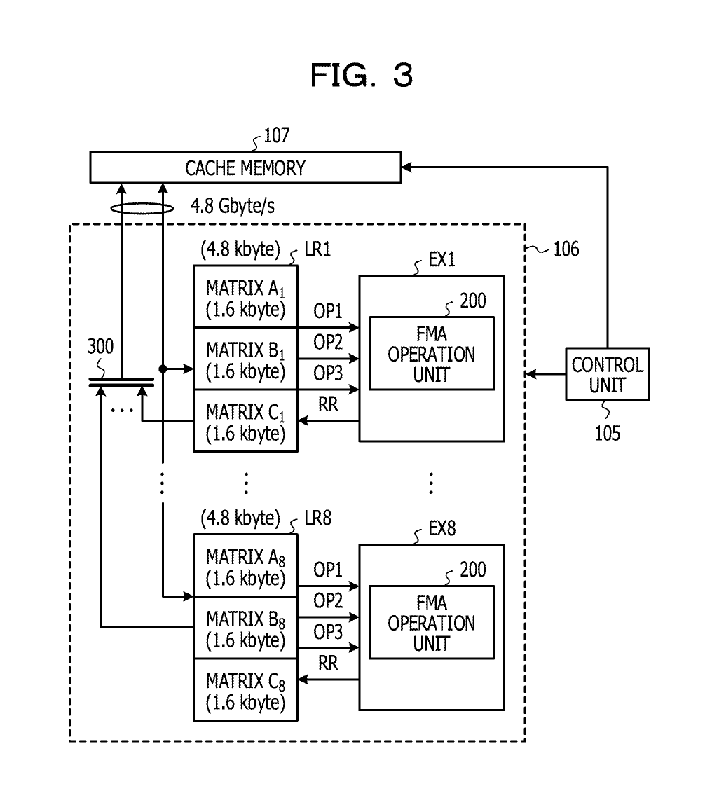

FIG. 3 illustrates an example of an execution unit. The execution unit 106 includes eight local vector registers LR1 to LR8, eight operation execution units EX1 to EX8, and a selector 300. Each of the operation execution units EX1 to EX8 includes one FMA operation unit 200. The FMA operation unit 200 is the same in configuration as the FMA operation unit 200 illustrated in FIG. 2.

The cache memory 107 stores the matrix data A and the matrix data B. When the operation processing apparatus 101 determines the product of the matrix data A and the matrix data B each having a large number of elements, each of the operation execution units EX1 to EX8 repeatedly calculates the product of small-size submatrices. The matrix data A, the matrix data B, and the matrix data C are each 200×200 square matrix data. Each of the eight FMA operation units 200 calculates a 20×20 matrix at a time. One element data includes 4 bytes.

Each of the operation execution units EX1 to EX8 calculates a 20×20 matrix. The control unit 105 transfers submatrix data A₁ with 20×20 matrix×4 bytes=1.6 kbytes in the matrix data A stored in the cache memory 107 to the local vector register LR1. The control unit 105 transfers submatrix data B₁ with 20×20 matrix×4 bytes=1.6 kbytes in the matrix data B stored in the cache memory 107 to the local vector register LR1.

Similarly, the control unit 105 transfers different submatrix data A₂ to A₈ each having 20×20 matrix×4 bytes=1.6 kbytes in the matrix data A stored in the cache memory 107 to the respective local vector registers LR2 to LR8. The control unit 105 transfers different submatrix data B₂ to B₈ each having 20×20 matrix×4 bytes=1.6 kbytes in the matrix data B stored in the cache memory 107 to the respective local vector registers LR2 to LR8.

Each of the operation execution units EX1 to EX 8 calculates a product of given one of 20×20 submatrix data A₁ to A₈ and corresponding one of 20×20 submatrix data B₁ to B₈ thereby determining one of different 20×20 submatrix data C₁ to C₈ in the matrix data C. The control unit 105 writes the 20×20 submatrix data C₁ to C₈ determined by the operation execution units EX1 to EX8 respectively in the local vector registers LR1 to LR8. The local vector registers LR1 to LR8 respectively store different submatrix data C₁ to C₈ each having 20×20 matrix×4 bytes=1.6 kbytes.

The local vector registers LR1 to LR8 each have a capacity of 1.6 kbytes×3 matrices=4.8 kbytes. The total capacity of the local vector registers LR1 to LR8 is 4.8 kbytes×8=38.4 kbytes.

A description is given below as to the number of multiply-add operation cycles performed to determine the product of 200×200 square matrices. To determine one element of a 20×20 square matrix, an operation is performed 20 times, and thus the operation is performed as many times as 20 times×400 elements=8000 times to determine the product of 20×20 square matrices. The execution unit 106 is capable of determining 20 elements of a 200×200 square matrix by performing an operation of determining the product of 20×20 square matrices 10 times. Thus, the number of multiply-add operation cycles is given as 20×10⁶ cycles according to equation (9).

(8000 times×10 times/20 elements)×40000 elements/8[the number of operation execution units]=20×10⁶ (9)

The amount of data used in determining the product of 200×200 square matrices is given as 96 Mbytes according to equation (10).

(4.8 kbytes×10 times/20 elements)×40000 elements=96 Mbytes (10)

As can be seen from the above discussion, the amount of data transferred between the cache memory 107 and the local vector registers LR1 to LR8 is 4.8 bytes/cycle as described in equation (11), In a case where the operation frequency is 1 GHz, the amount of data transferred per second is 4.8 Gbytes/s.

96 Mbytes/(20×10⁶ cycles)=4.8 bytes/cycle (11)

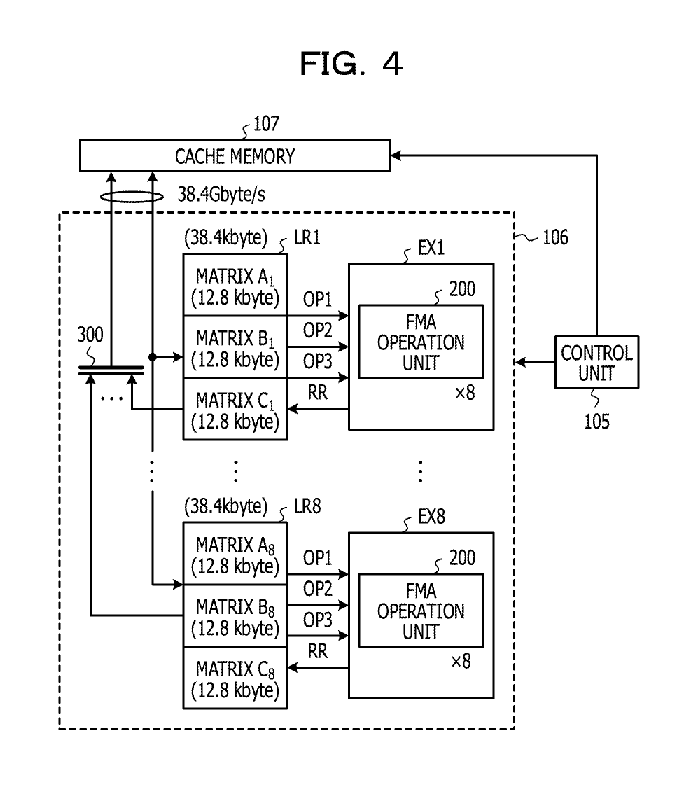

FIG. 4 illustrates an example of an execution unit. The execution unit 106 illustrated in FIG. 4 is different from the execution unit 106 illustrated in FIG. 3 in the configuration of operation execution units EX1 to EX8. Each of the operation execution units EX1 to EX8 illustrated in FIG. 3 includes one FMA operation unit 200. In contrast, each of the operation execution units EX1 to EX8 illustrated in FIG. 4 is a Single Instruction Multiple Data (SIMD) operation execution unit including eight FMA operation units 200. The SIMD execution units EX1 to EX8 perform the same type of operation on a plurality of pieces of data according to one operation instruction. The execution unit 106 illustrated in FIG. 4 is described below focusing on differences from the execution unit 106 illustrated in FIG. 3.

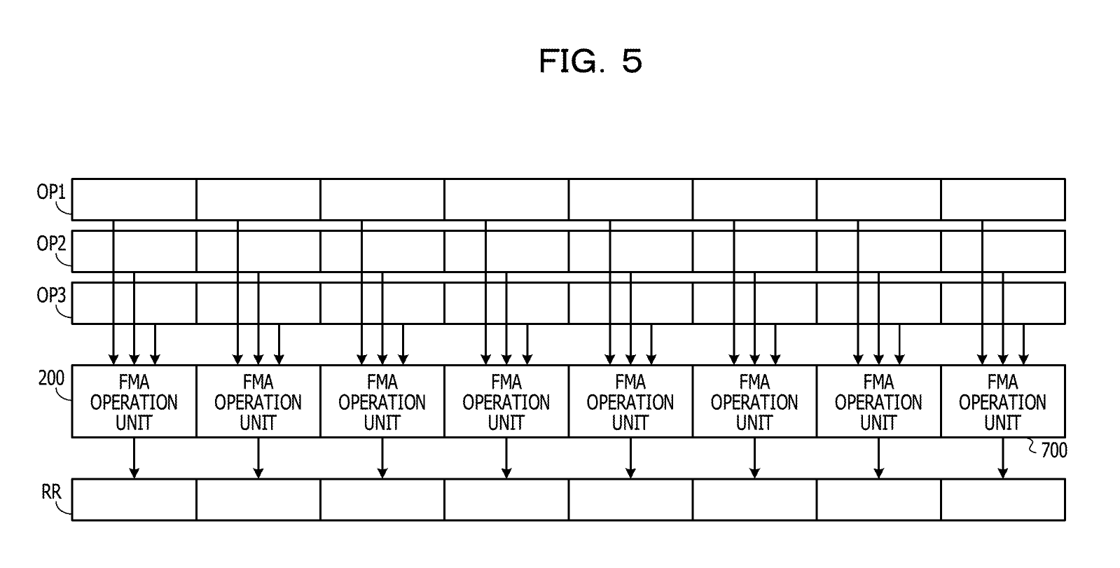

FIG. 5 illustrates an example of a set of eight FMA operation units in an operation execution unit. Each of the eight FMA operation units 200 receives inputs of data OP1 to OP3 different from each other, and outputs data RR.

Next, referring to FIG. 4, a description is given below as to the capacity of the local vector registers LR1 to LR8 each serving as a data storage unit. The operation execution units EX1 to EX8 illustrated in FIG. 4 each include eight times more FMA operation units 200 than each of the operation execution units EX1 to EX8 illustrated in FIG. 3 includes. Therefore, submatrix data A₁ illustrated in FIG. 4 has an eight times larger data size than the submatrix data A₁ illustrated in FIG. 3 has, and more specifically, the data size thereof is 1.6 kbytes×8=12.8 kbytes. Similarly, each of submatrix data A₂ to A₈, B₁ to B₈, and C₁ to C₈ has a data size of 12.8 kbytes. Thus, the capacity of the local vector register LR1 is 12.8 kbytes×3 matrices=38.4 kbytes. Similarly, each of the local vector registers LR2 to LR8 has a capacity of 12.8 kbytes×3 matrices=38.4 kbytes. The total capacity of the local vector registers LR1 to LR8 is 38.4 kbytes×8≈307 kbytes.

Next, a description is given below as to a data transfer rate between the cache memory 107 and the local vector registers LR1 to LR8. The data transfer rate in FIG. 4 is eight times higher than that in FIG. 3, and thus the data transfer rate in FIG. 4 is 4.8 Gbytes/s×8=38.4 Gbytes/s.

Next, a method of controlling the operation processing apparatus 101 is described below. The cache memory 107 stores the matrix data A and the matrix data B. The control unit 105 transfers respective submatrix data A₁ to A₈ stored in the cache memory 107 to the local vector registers LR1 to LR8. Next, the control unit 105 transfers respective submatrix data B₁ to B₈ stored in the cache memory 107 to the local vector registers LR1 to LR8. Subsequently, the local vector registers LR1 to LR8 respectively output the data OP1 to OP3 to the operation execution units EX1 to EX8 in every cycle. The operation execution units EX1 to EX8 each perform repeatedly a multiply-add operation using eight FMA operation units 200 and output eight pieces of data RR. The control unit 105 writes the data RR output by the operation execution units EX1 to EX8, as submatrix data C₁ to C₈, in the respective local vector registers LR1 to LR8. The control unit 105 then transfers the submatrix data C₁ to C₈ stored in the local vector registers LR1 to LR8 sequentially to the cache memory 107 via the selector 300.

In a case where the operation processing apparatus 101 does not satisfy the data transfer rate of 38.4 Gbytes/s described above, the operation execution units EX1 to EX8 do not receive data used in operations, and thus may cause the operation execution units EX1 to EX8 to pause. For example, an insufficient bus bandwidth may cause a reduction in performance. To perform the operation on the submatrix repeatedly, the operation processing apparatus 101 transfers the same matrix elements from the cache memory 107 to the local vector registers LR1 to LR8 a plural of times, which may result in a reduction in data transfer efficiency in the operation process.

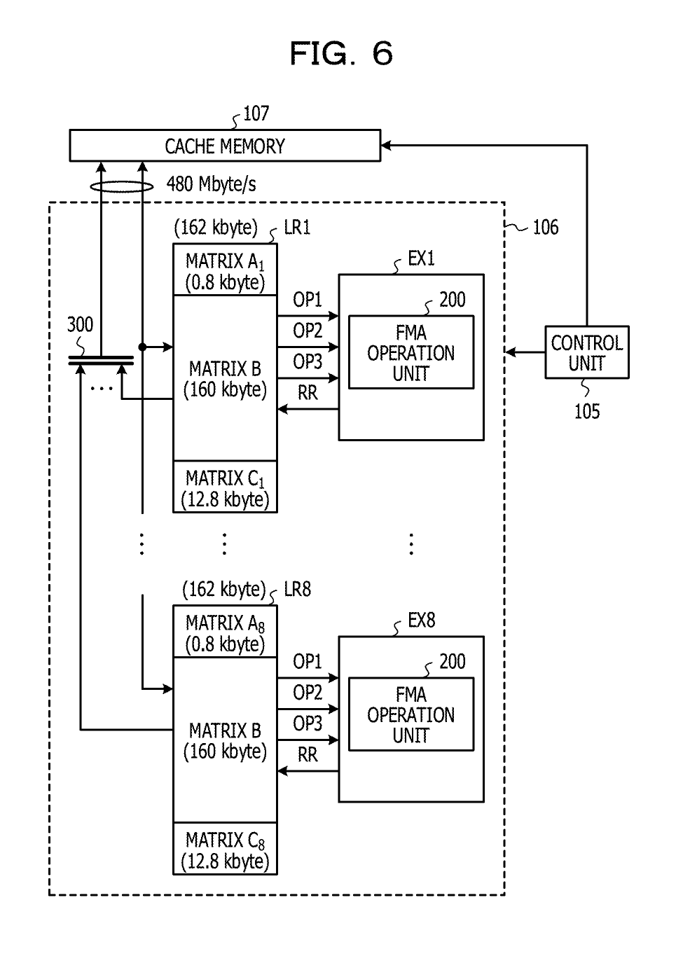

FIG. 6 illustrates an example of an execution unit. The execution unit 106 illustrated in FIG. 6 is different from the execution unit 106 illustrated in FIG. 3 in data stored in the local vector registers LR1 to LR8. Each of the operation execution units EX1 to EX8 includes one FMA operation unit 200. The cache memory 107 stores 200×200 matrix data A and 200×200 matrix data B. The execution unit 106 illustrated in FIG. 6 is described below focusing on differences from the execution unit 106 illustrated in FIG. 3.

When the execution unit 106 determines the product of the matrix data A and the matrix data B each having a large number of elements, the operation execution units EX1 to EX8 repeatedly calculate elements of the product of the matrices such that each operation execution unit calculates elements of one row (cᵢ₁, . . . , cᵢₚ) at a time. For example, the operation execution unit EX1 calculates first row data c₁₁, . . . , c₁ₚ of the matrix data C. The operation execution unit EX2 calculates second row data c₂₁, . . . , c₂ₚ of the matrix data C. The operation execution unit EX3 calculates third row data c₃₁, . . . , c₃ₚ of the matrix data C. Similarly, the operation execution units EX4 to EX8 respectively calculate fourth to eighth row data of the matrix data C. When the execution unit 106 determines the product of 200×200 square matrices, each FMA operation unit 200 performs a calculation of a 1×200 matrix. One element includes 4 bytes.

The control unit 105 transfers submatrix data A₁ with 1×200 matrix×4 bytes=0.8 kbytes of the matrix data A stored in the cache memory 107 to the local vector register LR1. The control unit 105 transfers matrix data B with 200×200 matrix×4 bytes=160 kbytes stored in the cache memory 107 to the local vector register LR1. Similarly, the control unit 105 transfers different submatrix data A₂ to A₈ each having 1×200 matrix×4 bytes=0.8 kbytes in the matrix data A stored in the cache memory 107 to the respective local vector registers LR2 to LR8. The control unit 105 transfers matrix data B with 200×200 matrix×4 bytes=160 kbytes stored in the cache memory 107 to the local vector registers LR2 to LR8. The local vector registers LR1 to LR8 each store all elements of the matrix data B.

Each of the operation execution units EX1 to EX8 calculates a product of given one of 1×200 submatrix data A₁ to A₈ and corresponding one of 200×200 matrix data B thereby determining one of different 1×200 submatrix data C₁ to C₈ in the matrix data C. For example, the operation execution unit EX1 calculates the multiply-add operation between first row data of the matrix data A and the matrix data B thereby determining first row data of the matrix data C. The operation execution unit EX 2 calculates the multiply-add operation between second row data of the matrix data A and the matrix data B thereby determining second row data of the matrix data C. The control unit 105 writes the 1×200 submatrix data C₁ to C₈ determined by the operation execution units EX1 to EX8 in the respective local vector registers LR1 to LR8. The local vector registers LR1 to LR8 respectively store different submatrix data C₁ to C₈ each having 1×200 matrix×4 bytes=0.8 kbytes.

Each of the local vector registers LR1 to LR8 has a capacity of 0.8 kbytes+160 kbytes+0.8 kbytes 162 kbytes. The total capacity of the local vector registers LR1 to LR8 is 162 kbytes×8≈1.3 Mbytes.

A description is given below as to the number of multiply-add operation cycles performed to determine the product of 200×200 square matrices. To determine one element of a 1×200 submatrix of the matrix data C, an operation is performed 200 times, and thus, to determine the 200×200 matrix data C, the number of multiply-add operation cycles is 1×10⁶ cycles according to equation (12).

200×200 matrix×200 times/8 [number of operation execution units]=1×10⁶ cycles (12)

The amount of data used in determining the product of 200×200 square matrices is 480 kbytes according to equation (13).

200×200 matrix×3 [number of matrices]×4 bytes=480 kbytes (13)

As can be seen from the above discussion, the amount of data transferred per cycle between the cache memory 107 and the local vector registers LR1 to LR8 is given as 4.8 bytes/cycle according to equation (14). In a case where the operation frequency is 1 GHz, the amount of data transferred per second is 480 Mbytes/s.

480 kbytes/(1×10⁶ cycles)=0.48 bytes/cycle (14)

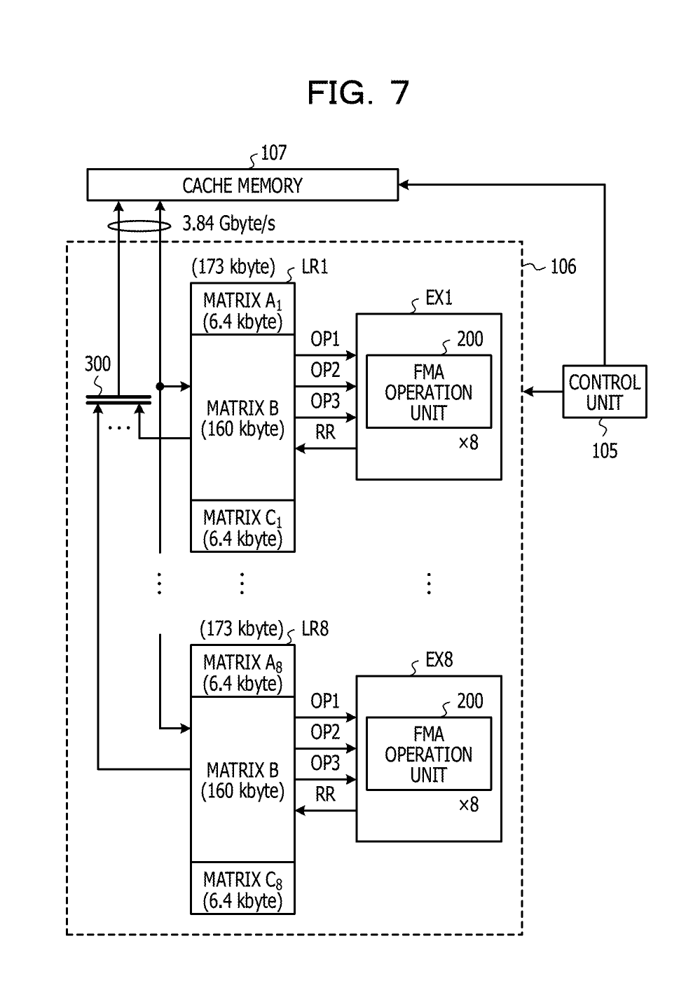

FIG. 7 illustrates an example of an execution unit. The execution unit 106 illustrated in FIG. 7 is different from the execution unit 106 illustrated in FIG. 6 in the configuration of operation execution units EX1 to EX8. Each of the operation execution units EX1 to EX8 illustrated in FIG. 6 includes one FMA operation unit 200. In contrast, each of the operation execution units EX1 to EX8 illustrated in FIG. 7 is a SIMD operation execution unit including eight FMA operation units 200. The execution unit 106 illustrated in FIG. 7 is described below focusing on differences from the execution unit 106 illustrated in FIG. 6.

The capacities of the local vector registers LR1 to LR8 are described below. The operation execution units EX1 to EX8 illustrated in FIG. 7 each include eight times more FMA operation units 200 than each of the operation execution units EX1 to EX8 illustrated in FIG. 6 includes. Submatrix data A₁ has a size of 1×200 matrix×8×4 bytes=6.4 kbytes. Similarly, each of submatrix data A₂ to A₈ and C₁ to C₈ has a data size of 6.4 kbytes. The matrix data B has a size of 200×200 matrix×4 bytes=160 kbytes. The local vector register LR1 has a capacity of 6.4 kbytes+160 kbytes+6.4 kbytes 173 kbytes. Similarly, each of the local vector registers LR2 to LR8 has a capacity of 173 kbytes. Thus the total capacity of local vector registers LR1 to LR8 is 173 kbytes×8≈1.4 Mbytes.

A description is given below as to a data transfer rate between the cache memory 107 and the local vector registers LR1 to LR8. The data transfer rate in FIG. 7 is eight times higher than that in FIG. 6, and thus the data transfer rate in FIG. 7 is 480 Mbytes/s×8=3.84 Gbytes/s.

In the operation processing apparatus 101 illustrated in FIG. 4, as described above, the total capacity of the local vector registers LR1 to LR8 is 307 kbytes, and data is transferred at a rate of 38.4 Gbytes/s. Thus, the relative data transfer rate of the operation processing apparatus 101 in FIG. 7 to that of the operation processing apparatus 101 in FIG. 4 is 3.84 G/38.4 G=1/10. However, the total capacity of the local vector registers LR1 to LR8 is as large as 1.4 M/307 k 4 times that illustrated in FIG. 4. Furthermore, most of contents stored in the local vector registers LR1 to LR8 in FIG. 7 are those associated with the same matrix data B, and thus their use efficiency is low.

The cache memory 107 stores the matrix data A and B. The control unit 105 transfers the submatrix data A₁ to A₈ stored in the cache memory 107 to the respective local vector registers LR1 to LR8, and transfers the matrix data B stored in the cache memory 107 to the local vector registers LR1 to LR8. Each of the local vector registers LR1 to LR8 stores all elements of the matrix data B. The local vector registers LR1 to LR8 respectively output the data OP1 to OP3 to the operation execution units EX1 to EX8 in every cycle. The operation execution units EX1 to EX8 each perform repeatedly a multiply-add operation using eight FMA operation units 200 and output eight pieces of data RR. The control unit 105 writes the data RR output by the operation execution units EX1 to EX8, as submatrix data C₁ to C₈, in the respective local vector registers LR1 to LR8. The control unit 105 then transfers the submatrix data C₁ to C₈ stored in the local vector registers LR1 to LR8 sequentially to the cache memory 107 via the selector 300.

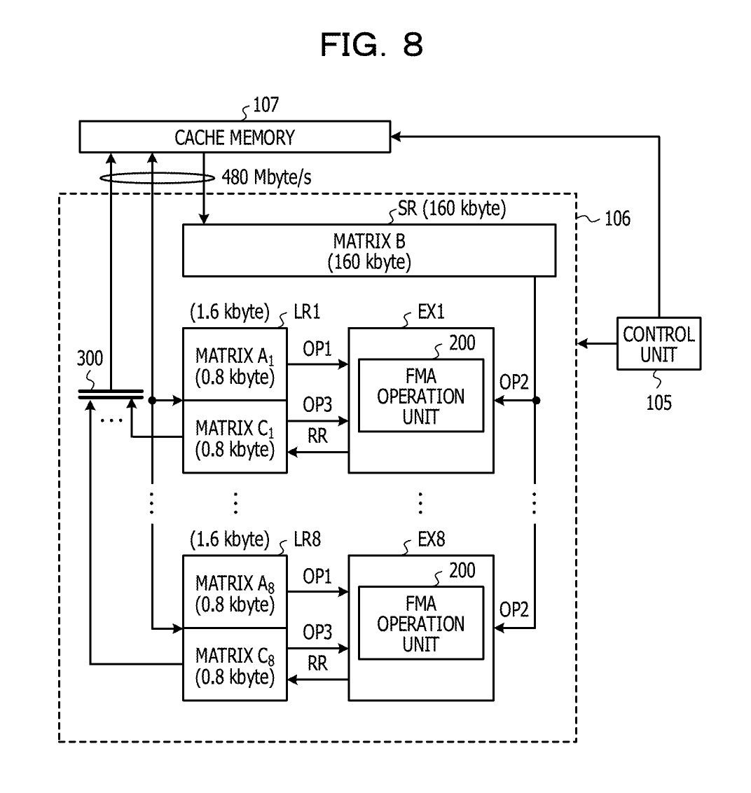

FIG. 8 illustrates an example of an execution unit. The execution unit 106 includes eight operation execution units EX1 to EX8, a selector 300, a shared vector register SR serving as a shared data storage unit shared by the operation execution units EX1 to EX8, and eight local vector registers LR1 to LR8 serving as data storage units disposed for the respective operation execution units EX1 to EX8. Each of the operation execution units EX1 to EX8 includes one FMA operation unit 200. The FMA operation unit 200 is the same in configuration as the FMA operation unit 200 illustrated in FIG. 2.

The cache memory 107 stores 200×200 matrix data A and 200×200 matrix data B. When the execution unit 106 determines the product of the matrix data A and the matrix data B, the operation execution units EX1 to EX8 repeatedly calculate elements of the product of the matrices such that each operation execution unit calculates elements of one row (cᵢ₁, . . . , c₁ₚ) at a time. For example, the operation execution unit EX1 calculates first row data c₁₁, . . . , c₁ₚ of the matrix data C. The operation execution unit EX 2 calculates second row data c₂₁, . . . , c₂ₚ of the matrix data C. The operation execution unit EX3 calculates third row data c₃₁, . . . , c₃ₚ of the matrix data C. Similarly, the operation execution units EX4 to EX8 respectively calculate fourth to eighth row data of the matrix data C. When the execution unit 106 determines the product of 200×200 square matrices, each FMA operation unit 200 calculates a 1×200 matrix. One element includes 4 bytes.

The control unit 105 transfers submatrix data A₁ with 1×200 matrix×4 bytes=0.8 kbytes of the first row matrix data A stored in the cache memory 107 to the local vector register LR1. Similarly, the control unit 105 transfers submatrix data A₂ to A₈ each having 1×200 matrix×4 bytes=0.8 kbytes of second to eighth rows of the matrix data A stored in the cache memory 107 to the respective local vector registers LR2 to LR8. Furthermore, the control unit 105 transfers matrix data B with 200×200 matrix×4 bytes=160 kbytes stored in the cache memory 107 to the shared vector register SR. The shared vector register SR stores all elements of the matrix data B.

The local vector registers LR1 to LR8 respectively output data OP1 and OP3 to the operation execution units EX1 to EX8. The shared vector register SR outputs data OP2 to the operation execution units EX1 to EX8. The data OP1 is submatrix data A₁ to A₈. The data OP2 is the matrix data B. The data OP3 is data RR in a previous cycle, and its initial value is 0.

The operation execution units EX1 to EX8 respectively calculate products of 1th to 8th 8×200 submatrix data A₁ to A₈ and the 200×200 matrix data B thereby determining respective 8×200 submatrix data C₁ to C₈ in the matrix data C. For example, the operation execution unit EX1 calculates the multiply-add operation between first row data of the matrix data A and the matrix data B thereby determining first row data of the matrix data C. The operation execution unit EX 2 calculates the multiply-add operation between second row data of the matrix data A and the matrix data B thereby determining second row data of the matrix data C. The control unit 105 writes the submatrix data C₁ to C₈ determined by the operation execution units EX1 to EX8 respectively in the respective local vector registers LR1 to LR8. The local vector registers LR1 to LR8 respectively store different submatrix data C₁ to C₈ each having 1×200 matrix×4 bytes=0.8 kbytes.

Thereafter, the operation processing apparatus 101 repeatedly performs the process described above in units of eight rows. For example, the control unit 105 transfers 8×200 submatrix data A₁ to A₈ of 9th to 16th rows of the matrix data A stored in the cache memory 107 to the local vector registers LR1 to LR8. The operation execution units EX1 to EX8 calculate products of respective 9th to 16th 8×200 submatrix data A₁ to A₈ and the 200×200 matrix data B thereby determining 9th to 16th 8×200 submatrix data C₁ to C₈. The operation processing apparatus 101 repeats the process described above until the 200th row.

The matrix data B has a data size of 160 kbytes. Therefore, the shared vector register SR has a capacity of 160 kbytes. The local vector registers LR1 to LR8 each have a capacity of 0.8 kbytes+0.8 kbytes=1.6 kbytes. The total capacity of the local vector registers LR1 to LR8 is 1.6 kbytes×8≈1.3 kbytes. The total capacity of the shared vector register SR and the local vector registers LR1 to LR8 is 160 kbytes+13 kbytes=173 kbytes.

A description is given below as to the number of multiply-add operation cycles performed to determine the product of 200×200 square matrices. To determine one element of a 1×200 submatrix of the matrix data C, an operation is performed 200 times, and thus, to determine the 200×200 matrix data C, the number of multiply-add operation cycles is 1×10⁶ cycles according to equation (15).

200×200 matrix×200 times/8 [number of operation execution units]=1×10⁶ cycles (15)

The amount of data used in determining the product of 200×200 square matrices is given as 480 kbytes according to equation (16).

200×200 matrix×3 [number of matrices]×4 bytes=480 kbytes (16)

As can be seen from the above discussion, the amount of data transferred between the cache memory 107 and the local vector registers LR1 to LR8 is given as 0.48 bytes/cycle according to equation (17). In a case where the operation frequency is 1 GHz, the amount of transferred data is 480 Mbytes/s.

480 kbytes/(1×10⁶ cycles)=0.48 bytes/cycle (17)

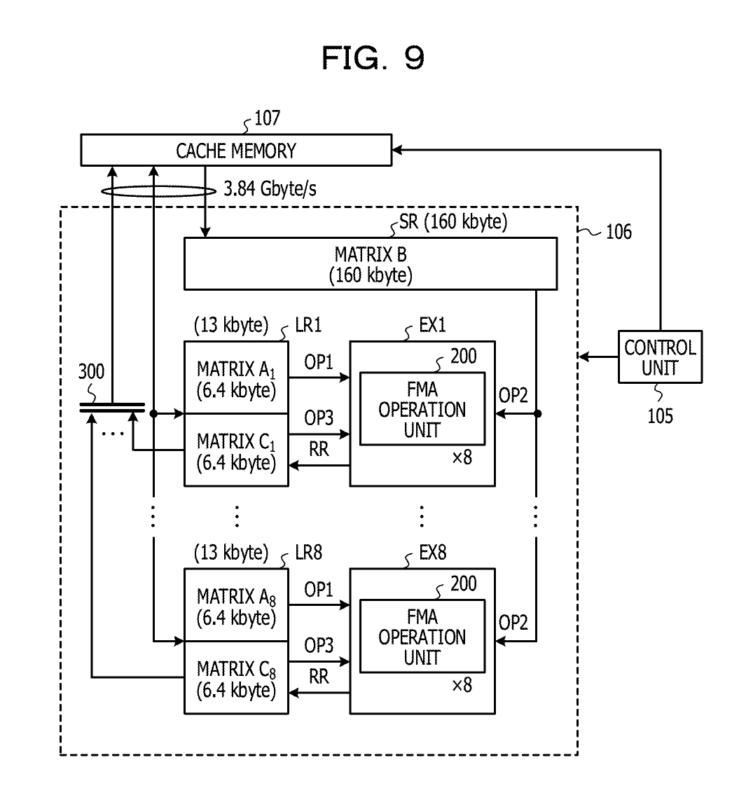

FIG. 9 illustrates an example of an execution unit. The execution unit 106 illustrated in FIG. 9 is different from the execution unit 106 illustrated in FIG. 8 in the configuration of operation execution units EX1 to EX8. Each of the operation execution units EX1 to EX8 illustrated in FIG. 8 includes one FMA operation unit 200. In contrast, each of the operation execution units EX1 to EX8 illustrated in FIG. 9 is a SIMD operation execution unit including eight FMA operation units 200. The execution unit 106 illustrated in FIG. 9 is described below focusing on differences from the execution unit 106 illustrated in FIG. 8.

The shared vector register SR in FIG. 9 has, as with the shared vector register SR in FIG. 8, a capacity of 160 kbytes. The operation execution units EX1 to EX8 in FIG. 9 each include eight times more FMA operation units 200 than each of the operation execution units EX1 to EX8 illustrated in FIG. 8 includes. The submatrix data A₁ has a size of 1×200 matrix×8×4 bytes=6.4 kbytes. Similarly, each of submatrix data A₂ to A₈ and C₁ to C₈ has a data size of 6.4 kbytes. Thus, the capacity of the local vector register LR1 is 6.4 kbytes+6.4 kbytes 13 kbytes. Similarly, each of the local vector registers LR2 to LR8 has a capacity of 13 kbytes. The total capacity of the local vector registers LR1 to LR8 is 13 kbytes×8=104 kbytes. The total capacity of the shared vector register SR and the local vector registers LR1 to LR8 is 160 kbytes+104 kbytes=264 kbytes.

A description is given below as to a data transfer rate between the cache memory 107 and the shared vector register SR and the local vector registers LR1 to LR8. The data transfer rate in FIG. 9 is eight times higher than that in FIG. 8, and thus the data transfer rate in FIG. 7 is 480 Mbytes/s×8=3.84 Gbytes/s.

In the operation processing apparatus 101 illustrated in FIG. 4, as described above, the total capacity of the local vector registers LR1 to LR8 is 307 kbytes, and data is transferred at a rate of 38.4 Gbytes/s. In the operation processing apparatus 101 illustrated in FIG. 7, as described above, the total capacity of the local vector registers LR1 to LR8 is 1.4 Mbytes, and data is transferred at a rate of 3.84 Gbytes/s.

Thus, the relative data transfer rate of the operation processing apparatus 101 in FIG. 9 to that of the operation processing apparatus 101 in FIG. 4 is 3.84 G/38.4 G=1/10, and the total capacity of the vector registers small (264 k/307 k), On the other hand, the data transfer rate of the operation processing apparatus 101 in FIG. 9 is equal to that of the operation processing apparatus 101 in FIG. 7 (3.84 Gbytes/s), and the relative total capacity of the vector registers is 264 k/1.4 M≈1/10.

The operation processing apparatus 101 illustrated in FIG. 4 repeats the operation of the submatrices, and thus the same matrix elements are transferred a plurality of times from the cache memory 107 to the local vector registers LR1 to LR8, which causes an increase in the amount of data transferred. In contrast, in the operation processing apparatus 101 illustrated in FIG. 9, the submatrix data A₁ to A₈ of the same row of the matrix A are transferred only once from the cache memory 107 to the local vector registers LR1 to LR8, and each element of the matrix data B is transferred only once from the cache memory 107 to the shared vector register SR, and thus a reduction is achieved in the amount of data transferred between the cache memory 107 and the vector registers.

In the operation processing apparatus 101 illustrated in FIG. 7, all elements of the matrix data B are stored in each of the eight local vector registers LR1 to LR8. In contrast, in the operation processing apparatus 101 illustrated in FIG. 9, all elements of the matrix data B are stored only in the shared vector register SR, and thus, a reduction in the total capacity of the vector registers is achieved.

Each of the local vector registers LR1 to LR8 includes output ports for providing data OP1 and OP3 to corresponding one of the operation execution units EX1 to EX8 and includes an input port for inputting data RR from the corresponding one of the operation execution units EX1 to EX8. In contrast, the shared vector register SR includes an output port for outputting data OP2 to the operation execution units EX1 to EX8, but includes no data input port. Therefore, the operation processing apparatus 101 illustrated in FIG. 9 provides a high ratio of the capacity to the area of the vector resistors compared with the operation processing apparatus 101 illustrated in FIG. 4 or FIG. 7. As described above, the operation processing apparatus 101 illustrated in FIG. 9 is small in terms of the amount of transferred data and the total capacity of vector register compared with the operation processing apparatus 101 illustrated in FIG. 4 or FIG. 7, which makes it possible to increase the operation efficiency and the cost merit.

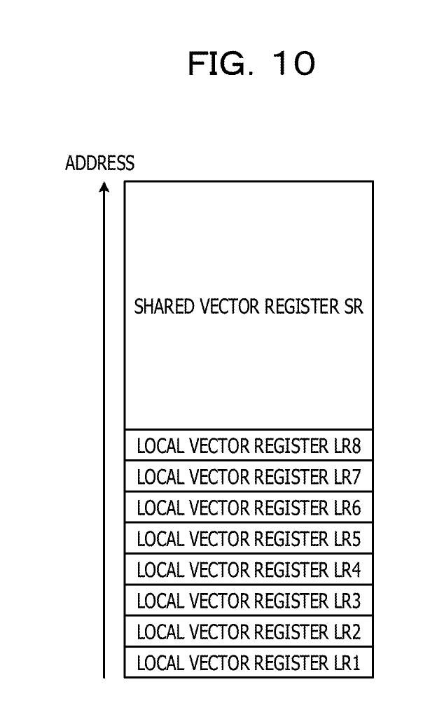

FIG. 10 illustrates an example of an address map of a shared vector register and a local vector register. Addresses of the shared vector register SR are assigned such that they are different from addresses of the local vector registers LR1 to LR8. Next, a description is given below as to a method by which the control unit 105 controls writing and reading to and from the shared vector register SR and the local vector registers LR1 to LR8. The control unit 105 controls the transferring and the operations described above by executing a program. The control unit 105 performs a control operation while distinguishing among addresses of the shared vector register SR and the local vector registers LR1 to LR8 by using an upper layer of the program or the like. This makes it possible for the control unit 105 to transfer the submatrix data A₁ to A₈ from the cache memory 107 to the local vector registers LR1 to LR8, and transfer the matrix data B from the cache memory 107 to the shared vector register SR.

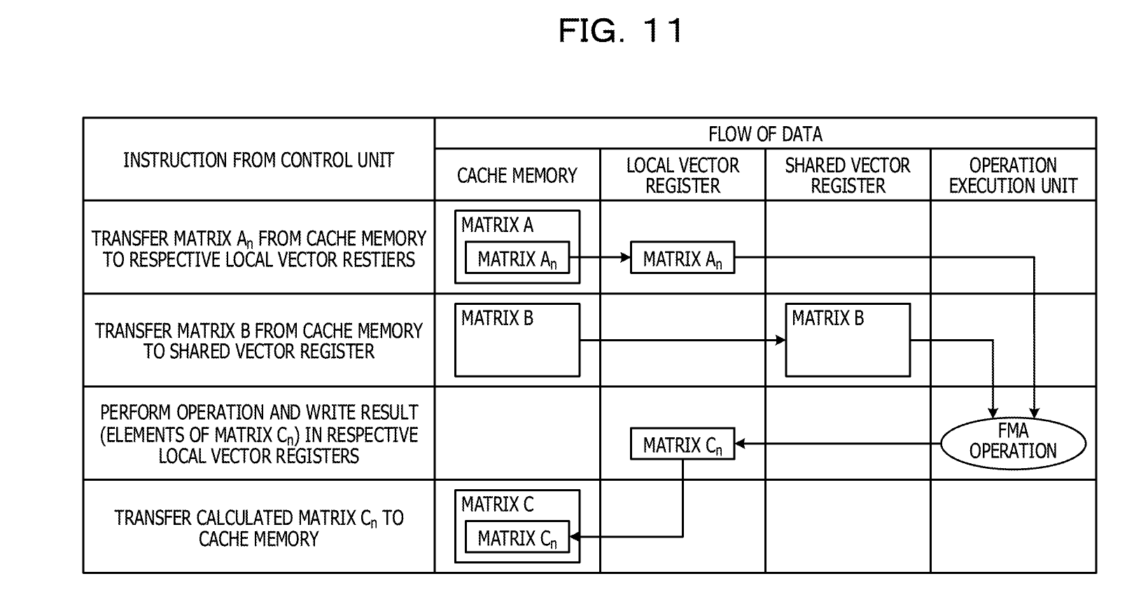

FIG. 11 illustrates an example of a method of controlling an operation processing apparatus. The method illustrated in FIG. 11 may be a method of controlling the operation processing apparatus illustrated in FIG. 9. The cache memory 107 stores 200×200 matrix data A and 200×200 matrix data B. The control unit 105 transfers 1st to 8th 8×200 submatrix data A₁ of the matrix data A stored in the cache memory 107 to the local vector register LR1. The control unit 105 transfers 9th to 16th 8×200 submatrix data A₂ of the matrix data A stored in the cache memory 107 to the local vector register LR2. Similarly, the control unit 105 performs transferring of data transfers 17th to 64th 48×200 submatrix data A₃ to A₈ in the matrix data A stored in the cache memory 107 to the local vector registers LR3 to LR8.

The control unit 105 transfers 200×200 matrix data B stored in the cache memory 107 to the shared vector register SR. The shared vector register SR stores all elements of the matrix data B. Each of the local vector registers LR1 to LR8 outputs data OP1 and OP3 to the operation execution units EX1 to EX8. The shared vector register SR outputs data OP2 to the operation execution units EX1 to EX8. The data OP1 is submatrix data A₁ to A₈. The data OP2 is the matrix data B, the data OP3 is data RR obtained in a previous cycle, and its initial value is 0. The matrix data B input to the operation execution units EX1 to EX8 from the shared vector register SR is equal for all operation execution units EX1 to EX8. Therefore, the shared vector register SR broadcasts the matrix data B to provide the matrix data B to all operation execution units EX1 to EX8.

The control unit 105 instructs the operation execution units EX1 to EX8 to start executing the multiply-add operation. The operation execution units EX1 to EX8 respectively calculate products of 8×200 submatrix data A₁ to A₈ and the 200×200 matrix data B thereby determining different 8×200 submatrix data C₁ to C₈ in the matrix data C. For example, the operation execution unit EX1 calculates the sum of products between 1st to 8th row data of the matrix data A and the matrix data B thereby determining 1st to 8th row data of the matrix data C. The operation execution unit EX 2 calculates the sum of products between 9th to 16th row data of the matrix data A and the matrix data B thereby determining 9th to 16th row data of the matrix data C. The control unit 105 writes the submatrix data C₁ to C₈ determined by the operation execution units EX1 to EX8 respectively in the respective local vector registers LR1 to LR8. The local vector registers LR1 to LR8 respectively store 8×200 submatrix data C₁ to C₈.

The control unit 105 transfers the submatrix data C₁ to C₈ stored in the local vector registers LR1 to LR8 sequentially to the cache memory 107 via the selector 300.

Thereafter, the operation processing apparatus 101 repeatedly performs the process described above in units of 64 rows. For example, the control unit 105 transfers 65th to 128th 64×200 submatrix data A₁ to A₈ of the matrix data A stored in the cache memory 107 to the local vector registers LR1 to LR8. The operation execution units EX1 to EX8 calculate products of 65th to 128th 64×200 submatrix data A₁ to A₈ and the 200×200 matrix data B thereby determining 65th to 128th 64×200 submatrix data C₁ to C₈. The operation processing apparatus 101 is connected to repeats the process described above until the 200th row. As a result, 200×200 matrix data C is stored in the cache memory 107.

The transferring by the control unit 105 and the operations by the operation execution units EX1 to EX8 are performed in parallel. That is, the operation execution units EX1 to EX8 operate when the control unit 105 is performing transferring, and thus no reduction in operation efficiency occurs.

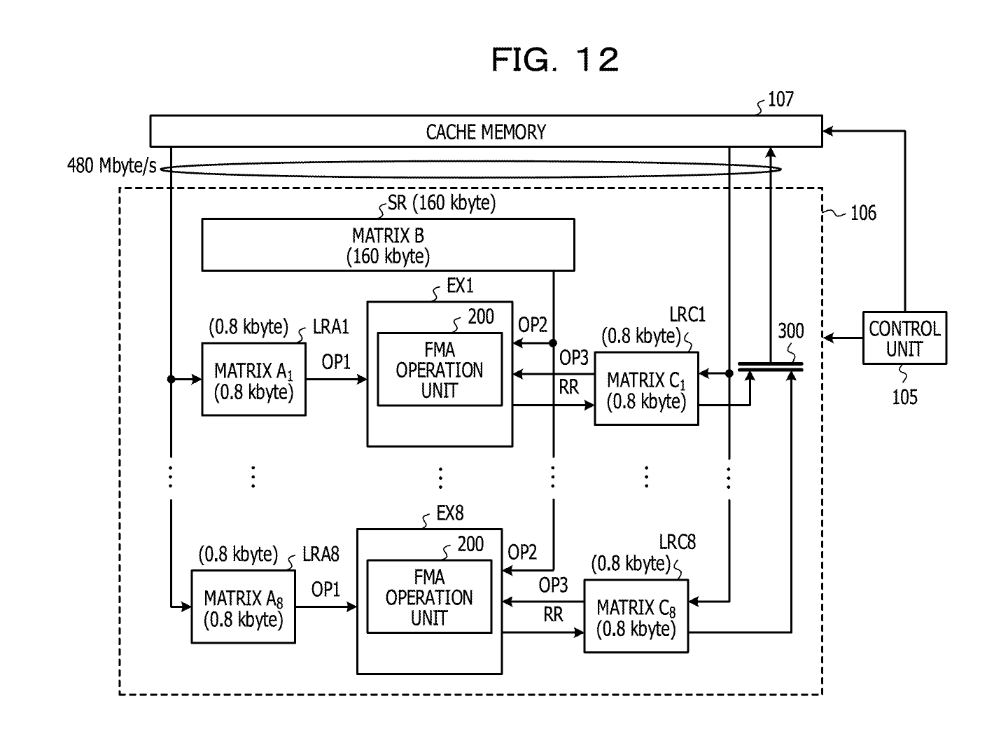

FIG. 12 illustrates an example of an execution unit. The execution unit 106 illustrated in FIG. 12 is different from the execution unit 106 illustrated in FIG. 8 in that local vector registers LRA1 to LRA8 and LRC1 to LRC8 are provided instead of the local vector registers LR1 to LR8. The execution unit 106 illustrated in FIG. 12 is described below focusing on differences from the execution unit 106 illustrated in FIG. 3.

The local vector registers LRA1 and LRC 1 are local vector registers obtained by dividing the local vector register LR1 illustrated in FIG. 8. The local vector register LRA 1 stores 1×200 submatrix data A₁ transferred from the cache memory 107, and outputs, as data OP1, the submatrix data A₁ to the operation execution unit EX1. The local vector register LRC 1 stores data RR as 1×200 submatrix data C₁ output from the operation execution unit EX1, and outputs data OP3 to the operation execution unit EX1.

Similarly, the local vector registers LRA2 to LRA8 and LRC2 to LRC 8 are local vector registers obtained by dividing the respective local vector registers LR2 to LR8 illustrated in FIG. 8. The local vector registers LRA2 to LRA8 respectively store 1×200 submatrix data A₂ to A₈ transferred from the cache memory 107, and output the submatrix data A₂ to A₈ as data OP1 to the operation execution units EX2 to EX8. The local vector registers LRC2 to LRC8 respectively store data RR, as 1×200 submatrix data C₂ to C₈, output from the operation execution units EX1 to EX8, and output data OP3 to the operation execution units EX2 to EX8.

The control unit 105 transfers the submatrix data C₁ to C₈ stored in the local vector registers LRC1 to LRC8 sequentially to the cache memory 107 via the selector 300.

The total capacity of the shared vector register SR and the local vector registers LRA1 to LRA8 and LRC1 to LRC8 is 173 kbytes, which is the same as the total capacity of the shared vector register SR and the local vector registers LR1 to LR8 illustrated in FIG. 8.

The data transfer rate between the cache memory 107 and the shared vector register SR and the local vector registers LRA1 to LRA8 and LRC1 to LRC8 is 480 Mbytes/s, which is the same as the data transfer rate between the cache memory 107 and the shared vector register SR and the local vector registers LR1 to LR8 illustrated in FIG. 8.

Each of the local vector registers LRC1 to LRC8 includes an output port for outputting data OP3 to the operation execution units EX1 to EX8, and includes an input port for inputting data RR from the corresponding one of the operation execution units EX1 to EX8. In contrast, each of the local vector registers LRA1 to LRA8 includes an output port for outputting data OP1 to the operation execution units EX1 to EX8, but includes no data input port. This makes it possible to reduce the number of parts and interconnections associated with the local vector registers LRA1 to LRA8 and increase efficiency in terms of the ratio of the capacity to the area of the vector registers.

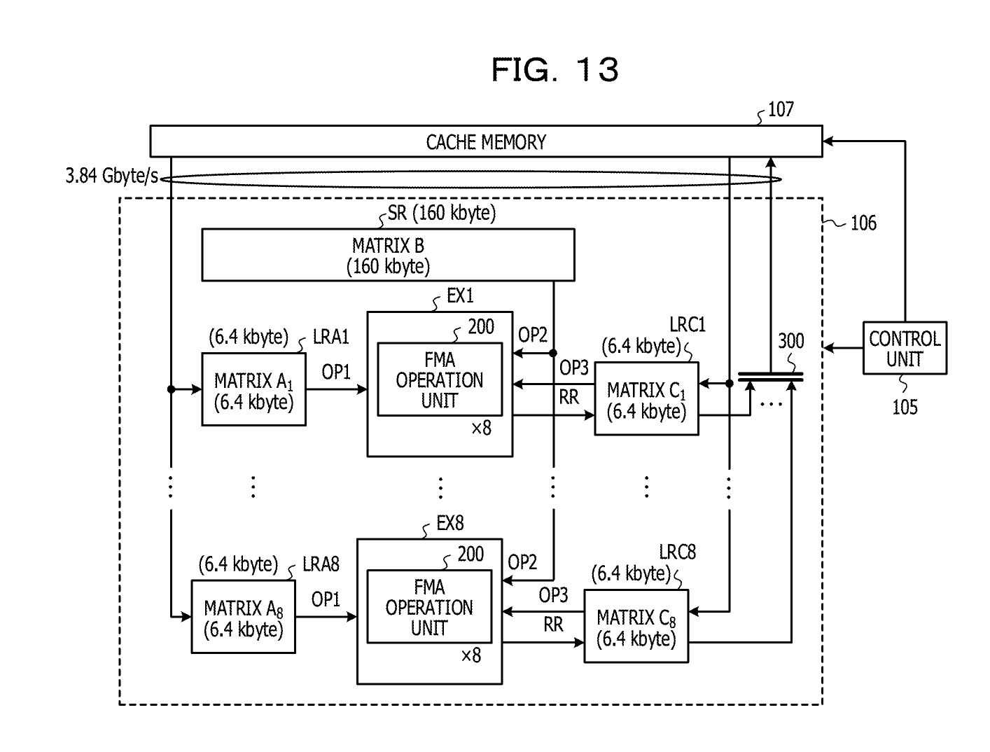

FIG. 13 illustrates an example of an execution unit. The execution unit 106 illustrated in FIG. 13 is different from the execution unit 106 illustrated in FIG. 12 in the configuration of operation execution units EX1 to EX8. Each of the operation execution units EX1 to EX8 illustrated in FIG. 12 includes one FMA operation unit 200. In contrast, each of the operation execution units EX1 to EX8 illustrated in FIG. 13 is a SIMD operation execution unit including eight FMA operation units 200. The execution unit 106 illustrated in FIG. 13 is described below focusing on differences from the execution unit 106 illustrated in FIG. 12.

The local vector registers LRA1 to LRA8 respectively store 8×200 submatrix data A₁ to A₈ and each of the local vector registers LRA1 to LRA8 has a data size of 6.4 kbytes. The local vector registers LRC1 to LRC8 respectively store 8×200 submatrix data C₁ to C₈ and each of the local vector registers LRC1 to LRC8 has a data size of 6.4 kbytes.

The total capacity of the shared vector register SR and the local vector registers LRA1 to LRA8 and LRC1 to LRC8 is 264 kbytes, which is the same as the total capacity of the shared vector register SR and the local vector registers LR1 to LR8 illustrated in FIG. 9.

The data transfer rate between the cache memory 107 and the shared vector register SR and the local vector registers LRA1 to LRA8 and LRC1 to LRC8 is 3.84 Gbytes/s, which is the same as the data transfer rate between the cache memory 107 and the shared vector register SR and the local vector registers LR1 to LR8 illustrated in FIG. 9.

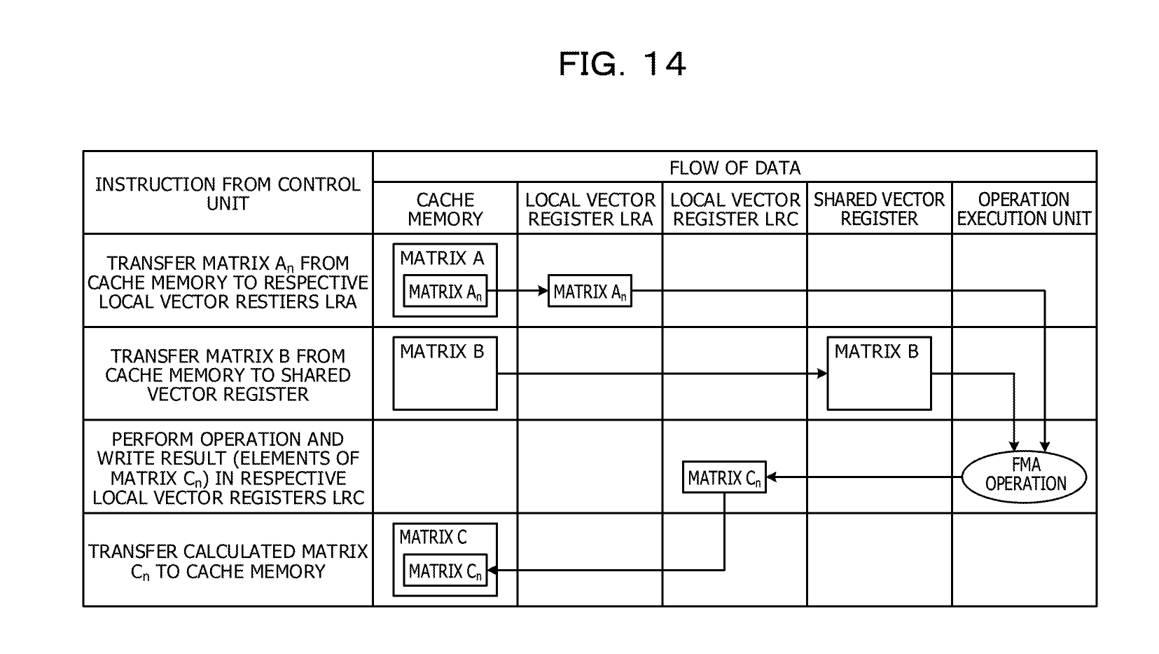

FIG. 14 illustrates an example of a method of controlling an operation processing apparatus. The method illustrated in FIG. 14 may be a method of controlling the operation processing apparatus illustrated in FIG. 13. The cache memory 107 stores 200×200 matrix data A and 200×200 matrix data B. The control unit 105 transfers 1st to 8th 8×200 submatrix data A₁ of the matrix data A stored in the cache memory 107 to the local vector register LRA1. The control unit 105 transfers 9th to 16th 8×200 submatrix data A₂ of the matrix data A stored in the cache memory 107 to the local vector register LRA2. Similarly, the control unit 105 transfers 17th to 64th 48×200 submatrix data A₃ to A₈ in the matrix data A stored in the cache memory 107 to the local vector registers LRA3 to LRA8.

The control unit 105 transfers 200×200 matrix data B stored in the cache memory 107 to the shared vector register SR. The shared vector register SR stores all elements of the matrix data B. The local vector registers LRA1 to LRA8 respectively output data OP1 to the operation execution units EX1 to EX8. The shared vector register SR outputs data OP2 to the operation execution units EX1 to EX8. The local vector registers LRC1 to LRC8 respectively output data OP3 to the operation execution units EX1 to EX8. The data OP1 is submatrix data A₁ to A₈. The data OP2 is matrix data B. The data OP3 is data RR in a previous cycle, and its initial value is 0.

The control unit 105 instructs the operation execution units EX1 to EX8 to start executing the multiply-add operation. The operation execution units EX1 to EX8 respectively calculate products of 8×200 submatrix data A₁ to A₈ and the 200×200 matrix data B thereby determining respective different 8×200 submatrix data C₁ to C₈ in the matrix data C. For example, the operation execution unit EX1 calculates the sum of products between 1st to 8th row data of the matrix data A and the matrix data B thereby determining 1st to 8th row data of the matrix data C. The operation execution unit EX2 calculates the sum of products between 9th to 16th row data of the matrix data A and the matrix data B thereby determining 9th to 16th row data of the matrix data C. The control unit 105 writes the submatrix data C₁ to C₈ determined by the operation execution units EX1 to EX8 respectively in the respective local vector registers LRC1 to LRC8. The local vector registers LRC1 to LRC8 respectively store 8×200 submatrix data C₁ to C₈.

The control unit 105 transfers the submatrix data C₁ to C₈ stored in the local vector registers LRC1 to LRC8 sequentially to the cache memory 107 via the selector 300.

Thereafter, the operation processing apparatus 101 repeatedly performs the process described above in units of 64 rows. For example, the control unit 105 transfers 65th to 128th 64×200 submatrix data A₁ to A₈ of the matrix data A stored in the cache memory 107 to the local vector registers LRA1 to LRA8. The operation execution units EX1 to EX 8 respectively calculate products of 65th to 128th 64×200 submatrix data A₁ to A₈ and the 200×200 matrix data B thereby determining 65th to 128th 64×200 submatrix data C₁ to C₈. The operation processing apparatus 101 repeats the process described above until the 200th row. As a result, 200×200 matrix data C is stored in the cache memory 107.

The transferring by the control unit 105 and the operations by the operation execution units EX1 to EX8 are performed in parallel. That is, the operation execution units EX1 to EX8 operate when the control unit 105 is performing transferring, and thus no reduction in operation efficiency occurs.

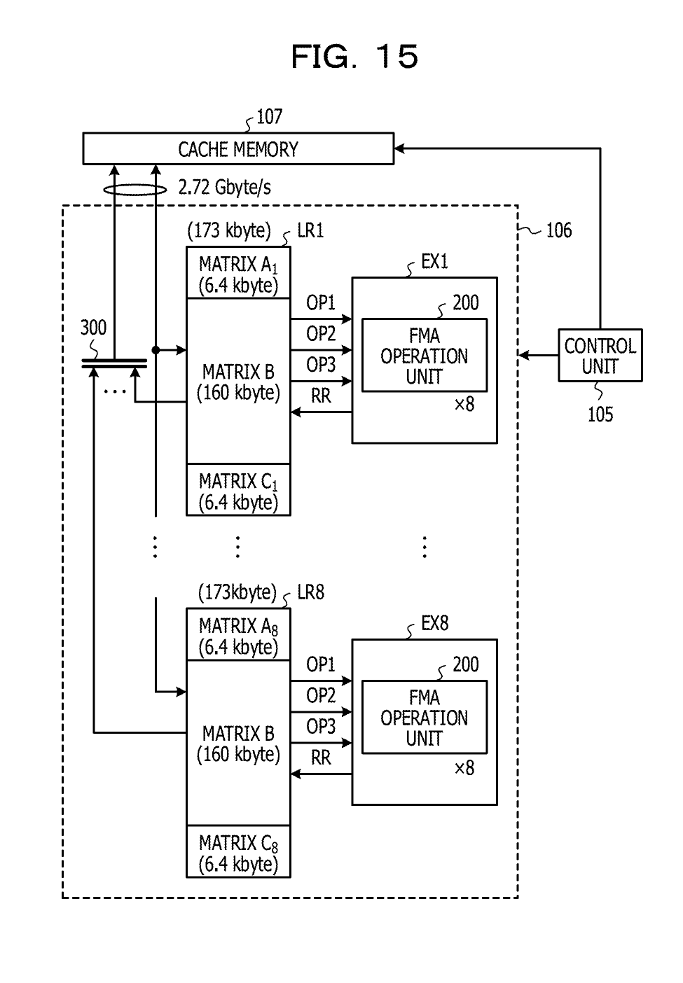

FIG. 15 illustrates an example of an execution unit. The execution unit 106 illustrated in FIG. 15 is similar to the execution unit 106 illustrated in FIG. 7 in configuration but is different in a control method. The execution unit 106 includes eight local vector registers LR1 to LR8, eight operation execution units EX1 to EX8, and a selector 300. Each of the operation execution units EX1 to EX8 includes eight FMA operation units 200. The local vector register LR1 stores 8×200 submatrix data A₁, 200×200 matrix data B, and 8×200 submatrix data C₁. Similarly, the local vector registers LR2 to LR8 respectively store 8×200 submatrix data A₂ to A₈, 200×200 matrix data B, and 8×200 submatrix data C₂ to C₈. Thus, the total capacity of local vector registers LR1 to LR8 is the same as that illustrated in FIG. 7, that is, it is 173 kbytes×8=1.4 Mbytes. The operation processing apparatus 101 illustrated in FIG. 15 is described below focusing on differences from the operation processing apparatus 101 illustrated in FIG. 7.

A method of controlling the operation processing apparatus 101 illustrated in FIG. 7 is described below. The control unit 105 transfers the submatrix data A₁ from the cache memory 107 to the local vector register LR1, and transfers the matrix data B from the cache memory 107 to the local vector register LR1. The control unit 105 transfers the submatrix data A₂ from the cache memory 107 to the local vector register LR2, and transfer the matrix data B from the cache memory 107 to the local vector register LR2. Thereafter, similarly, the control unit 105 transfers the submatrix data A₃ to A₈ from the cache memory 107 sequentially to the local vector registers LR3 to LR8, and transfers the matrix data B from the cache memory 107 sequentially to the local vector registers LR3 to LR8. The data transfer rate between the cache memory 107 and the local vector registers LR1 to LR8 is 3.84 Gbytes/s as described above.

The control unit 105 of the operation processing apparatus 101 illustrated in FIG. 15 transfers the submatrix data A₁ from the cache memory 107 to the local vector register LR1. The control unit 105 controls transferring the submatrix data A₂ from the cache memory 107 to the local vector register LR2. Next, similarly, the control unit 105 transfers the submatrix data A₃ to A₈ from the cache memory 107 sequentially to the local vector registers LR3 to LR8. Next, the control unit 105 reads out the matrix data B from the cache memory 107. The cache memory 107 outputs the matrix data B to the local vector registers LR1 to LR8 by broadcasting. The control unit 105 writes the same matrix data B in the local vector registers LR1 to LR8 simultaneously.

The amount of data of the matrix data B transferred by the operation processing apparatus 101 illustrated in FIG. 7 from the cache memory 107 to the local vector registers LR1 to LR8 is 160 kbytes×8. In contrast, the amount of data of the matrix data B transferred by the operation processing apparatus 101 illustrated in FIG. 15 from the cache memory 107 to the local vector registers LR1 to LR8 is 160 kbytes. Therefore, in the operation processing apparatus 101 illustrated in FIG. 15, the data transfer rate between the cache memory 107 and the local vector registers LR1 to LR8 is 3.84 Gbytes/s−160 k×7=2.72 Gbytes/s, that is, the data transfer rate is lower than that in FIG. 7, and thus an improvement in operation efficiency is achieved.

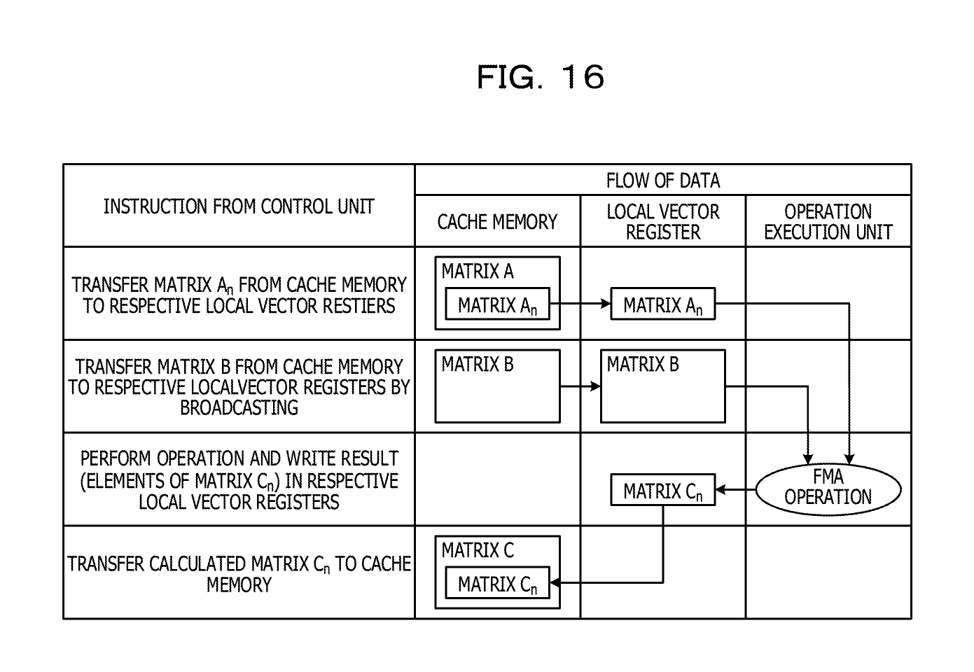

FIG. 16 illustrates an example of a method of controlling an operation processing apparatus. The method illustrated in FIG. 16 may be a method of controlling the operation processing apparatus illustrated in FIG. 15. The cache memory 107 stores 200×200 matrix data A and 200×200 matrix data B. The control unit 105 reads out 1st to 8th 8×200 submatrix data A₁ of the matrix data A stored in the cache memory 107 and writes the submatrix data A₁ in the local vector register LR1. The control unit 105 reads out 9th to 16th 8×200 submatrix data A₂ of the matrix data A stored in the cache memory 107 and writes the submatrix data A₂ in the local vector register LR2. Similarly, the control unit 105 sequentially reads out 17th to 64th 8×200 submatrix data A₃ to A₈ of the matrix data A stored in the cache memory 107, and sequentially writes the submatrix data A₃ to A₈ in the local vector registers LR3 to LR8.

The control unit 105 reads out 200×200 matrix data B stored in the cache memory 107. The cache memory 107 outputs the matrix data B to the local vector registers LR1 to LR8 by broadcasting. The control unit 105 writhes the same matrix data B in the local vector registers LR1 to LR8 simultaneously. The local vector registers LR1 to LR8 respectively output data OP1 to OP3 to the operation execution units EX1 to EX8. The data OP1 is submatrix data A₁ to A₈. The data OP2 is matrix data B. The data OP3 is data RR in a previous cycle, and its initial value is 0.

The control unit 105 instructs the operation execution units EX1 to EX8 to start executing the multiply-add operation. The operation execution units EX1 to EX8 respectively calculate products of 8×200 submatrix data A₁ to A₈ and the 200×200 matrix data B thereby determining respective different 8×200 submatrix data C₁ to C₈ in the matrix data C. For example, the operation execution unit EX1 calculates the sum of products between 1st to 8th row data of the matrix data A and the matrix data B thereby determining 1st to 8th row data of the matrix data C. The operation execution unit EX2 calculates the sum of products between 9th to 16th row data of the matrix data A and the matrix data B thereby determining 9th to 16th row data of the matrix data C. The control unit 105 writes the submatrix data C₁ to C₈ determined by the operation execution units EX1 to EX8 respectively in the respective local vector registers LR1 to LR8. The local vector registers LR1 to LR8 respectively store 8×200 submatrix data C₁ to C₈.

The control unit 105 transfers submatrix data C₁ to C₈ stored in the local vector registers LR1 to LR8 sequentially to the cache memory 107 via the selector 300.

Thereafter, the operation processing apparatus 101 repeatedly performs the process described above in units of 64 rows. For example, the control unit 105 transfers 65th to 128th 64×200 submatrix data A₁ to A₈ of the matrix data A stored in the cache memory 107 to the local vector registers LR1 to LR8. The operation execution units EX1 to EX8 calculate products of 65th to 128th 64×200 submatrix data A₁ to A₈ and the 200×200 matrix data B thereby determining 65th to 128th 64×200 submatrix data C₁ to C₈. The operation processing apparatus 101 repeats the process described above until the 200th row. As a result, 200×200 matrix data C is stored in the cache memory 107.

In the operation processing apparatus, as described above, a reduction in the amount of data transferred in the operation by the operation execution units EX1 to EX8 is achieved and/or a reduction in the capacity of vector registers is achieved. This may make it possible for the operation processing apparatus 101 to provide an improved performance in calculation of a product of matrices or the like in scientific computing as much as the increased number of operation execution units EX1 to EX8.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An operation processing apparatus comprising:
a plurality of operation elements;
a plurality of first data storages disposed so as to correspond to the respective operation elements and each configured to store first data; and
a shared data storage shared by the plurality of operation elements and configured to store second data,
each of the plurality of operation elements are configured to perform an operation using the first data and the second data.

2. The operation processing apparatus according to claim 1, wherein the first data is first matrix data,
the second data is second matrix data, and
the plurality of operation elements perform an operation on the first matrix data and the second matrix data.

3. The operation processing apparatus according to claim 2, wherein
the plurality of first data storages each store different row data of the first matrix data,
each of the plurality of operation elements:
calculates a sum of products between one row data of the first matrix data and one column data of the second matrix data:
determines a product of the first matrix data and the second matrix data; and
outputs third matrix data.

4. The operation processing apparatus according to claim 3, wherein
the plurality of first data storages each store one of different pieces of different row data of the first matrix data, and
each of the plurality of operation elements performs one multiply-add operation process.

5. The operation processing apparatus according to claim 3, wherein
the plurality of first data storages respectively store a plurality of pieces of different row data of the first matrix data, and
the plurality of operation elements perform a plurality of multiply-add operation processes in parallel.

6. The operation processing apparatus according to claim 3, wherein the plurality of operation elements respectively write the third matrix data in the plurality of first data storages.

7. The operation processing apparatus according to claim 6, further comprising:
a memory configured to store the first matrix data and the second matrix data; and
a controller configured to transfer the first matrix data stored in the memory to the plurality of first data storages, transfer the second matrix data stored in the memory to the shared data storage, and transfer the third matrix data stored in the plurality of first data storages to the memory.

8. The operation processing apparatus according to claim 3, further comprising:
a plurality of second data storages,
wherein the plurality of operation elements write the third matrix data in the respective second data storages.

9. An information processing apparatus comprising:
a memory configured to store data;
a plurality of data storages;
a controller configured to write different first data stored in the memory in the plurality of data storages and write the same second data stored in the memory in the plurality of data storages simultaneously; and
a plurality of operation elements disposed so as to correspond to the respective data storages and configured to perform an operation using the first data and the second data stored in the plurality of data storages and to write the third data in the plurality of data storages,
the controller transfers the third data stored in the plurality of data storages to the memory.

10. The information processing apparatus according to claim 9, wherein
the first data is first matrix data,
the second data is second matrix data,
the third data is third matrix data, and
the plurality of operation elements perform an operation of the first matrix data and the second matrix data, and output the third matrix data.

11. The information processing apparatus according to claim 10,
wherein the plurality of data storages respectively store different row data of the first matrix data,
each of the plurality of operation elements:
calculates a sum of products between one row data of the first matrix data and one column data of the second matrix data;
determines a product of the first matrix data and the second matrix data; and
outputs the third matrix data.

12. The information processing apparatus according to claim 11, wherein
the plurality of data storages respectively store a plurality of pieces of different row data of the first matrix data, and
the plurality of operation elements perform a plurality of multiply-add operation processes in parallel.

13. A method of controlling an operation processing apparatus comprising:
storing first data in a plurality of first data storages disposed so as to correspond to respective operation elements;
storing a second data in a shared data storage shared by the operation elements; and
performing, by the operation elements, an operation using the first data and the second data.

14. The method according to claim 13, wherein
the first data is first matrix data,
the second data is second matrix data, and
the plurality of operation elements perform an operation on the first matrix data and the second matrix data.

15. The method according to claim 14, wherein
the plurality of first data storages each store different row data of the first matrix data, and further comprising:
calculating a sum of products between one row data of the first matrix data and one column data of the second matrix data:
determining a product of the first matrix data and the second matrix data; and
outputting third matrix data.

16. The method according to claim 15, wherein
the plurality of first data storages each store one of different pieces of different row data of the first matrix data, and
each of the plurality of operation elements performs one multiply-add operation process.

17. The method according to claim 15, wherein
the plurality of first data storages respectively store a plurality of pieces of different row data of the first matrix data, and
the plurality of operation elements perform a plurality of multiply-add operation processes in parallel.

18. The method according to claim 15, wherein the plurality of operation elements respectively write the third matrix data in the plurality of first data storages.

19. The method according to claim 18, further comprising:
storing the first matrix data and the second matrix data in a memory; and
transferring, by a controller, the first matrix data stored in the memory to the plurality of first data storages;
transferring the second matrix data stored in the memory to the shared data storage; and
transferring the third matrix data stored in the plurality of first data storages to the memory.

20. The method according to claim 15, further comprising:
writing the third matrix data in respective second data storages.
